(19) United States
(12) Patent Application Publication
(10) Pub. No.: US 2016/0301044 A1
(43) Pub. Date: Oct. 13, 2016

(54) Flexible Battery System for Portable Device

(71) Applicants: Zhen Huang, Carmel, IN (US); Grover Knight, Carmel, IN (US)

(72) Inventors: Zhen Huang, Carmel, IN (US); Grover Knight, Carmel, IN (US)

(21) Appl. No.: 15/093,859

(22) Filed: Apr. 8, 2016

Related U.S. Application Data
(60) Provisional application No. 62/145,812, filed on Apr. 10, 2015.

(51) Int. Cl. H01M 2/10; H01M 10/48; H01M 10/42

(52) U.S. Cl. CPC H01M 2/1022; H01M 10/425; H01M 10/482; H01M 2220/30; H01M 2010/4271; H01M 2010/4278

(57) ABSTRACT

A battery pack apparatus includes a flexible battery pack with an attachment component for attaching the battery pack to and supporting the battery pack on the arms of goggles or eyeglasses worn by a user, the goggles/eyeglasses supporting an electrical device requiring power from the battery pack. The flexible battery pack counter-balances the weight of at least the electrical device when the goggles/eyeglasses are worn by the user. The battery pack apparatus includes a controller that may be wired or remote and that is operable to control the operation of the battery cells within the battery pack.

### PRIORITY CLAIM

This application is a utility filing of and claims priority to provisional application No. 62/145,812, filed on Apr. 10, 2015, the entire disclosure of which is incorporated herein by reference.

### FIELD OF THE INVENTION

The present invention relates generally to an apparatus and method for providing a power source for portable devices. More specifically, the present invention relates to an apparatus for providing a controllable power source for general wearable device such as, telescopes/loupes, watches, headlights, and the like.

### BACKGROUND

There is a wide array of wearable electronic devices such as headlights, vision goggles, telescopes/loupes, dental telescopes/loupes, surgical telescopes/loupes, electronic watches, health monitors, etc. The operation time of those devices is limited by the power source integrated into the device itself. The typical battery for portable or wearable devices has short working lifetime in order to reduce the size and weight of the battery pack and ultimately of the devices.

There is a significant need for an additional or optional power supply to power these wearable devices. However, it is challenging to connect a power source to the human body to supply extra power to the wearable device due to the motion and characteristic of the body. It is desirable to mount the extra power source as close as possible to the device to reduce the length and exposure of the power supply wires between the device and the power source, which may ordinarily be easily twisted or even severed due to the person's body movement.

### SUMMARY

The present invention provides an apparatus and method for creating a flexible rechargeable battery system which can be easily supported by some parts of human body. The present apparatus will significantly reduce the connection wire length between the device and power source. This apparatus can be used as a general or an auxiliary power source to provide power to variety of wearable devices.

The present invention is a system which provides extra energy source to the electronic device. The system includes a flexible battery pack and mechanism to attach to the human body. This system may be used as the general portable power system for verities of electronic devices. The battery pack is designed to be scalable so that it can produce desired voltage and lifetime for the electronic devices. The battery pack is designed to be flexible so that it can easily wrap around the human body such as arm, head, neck etc without becoming uncomfortable.

### BRIEF DESCRIPTION OF THE DRAWINGS

FIG. 1 is a perspective view of a flexible battery pack according to one embodiment which can be attached to the body using a strap.

FIG. 2 is a perspective view of a flexible battery pack in a tube according to a further embodiment.

FIG. 3 is a rear view of a person wearing a flexible battery pack, such as the battery packs shown in FIG. 1 or 2, with the battery pack electrically connected to a goggle.

FIG. 4 is front perspective view of a person wearing a flexible battery pack, such as the battery packs shown in FIG. 1 or 2, about the neck of the person.

FIG. 5 is a diagram showing other places on the body that a person can wear a flexible battery pack, such as the battery packs shown in FIG. 1 or 2.

FIG. 6 is a diagram illustrating a linked flexible battery pack according to a further embodiment.

FIG. 7 is a perspective view of a flexible battery pack, such as the battery packs shown in FIG. 1 or 2, associated with a device incorporating goggles with a headlight powered by the battery pack.

FIG. 8 is a side perspective view of a flexible battery pack connected to a goggles and headlight device according to a further embodiment.

FIG. 9 is a diagram of a flexible battery pack incorporated into a strap for engaging the frame of eyeglasses or goggles, according to an additional embodiment.

### DETAIL DESCRIPTIONS OF THE INVENTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

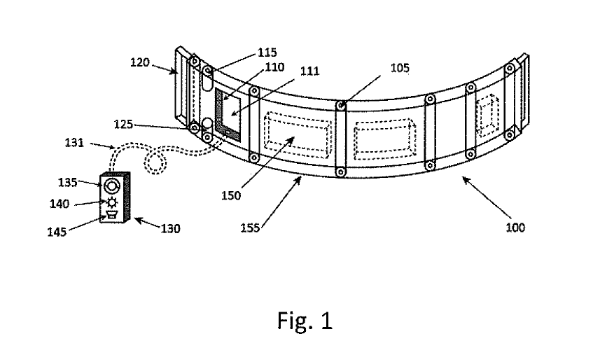

The present invention provides a flexible battery pack 100 that is a scalable standalone electronic device as shown in the FIG. 1. The flexible battery pack may contain multiple battery cells 155 to meet the requirement for voltage and battery lifetime for the device to which the battery pack is connected. The flexible battery pack may provide different voltage level to power the devices and may include a control circuit which allows the user to select the desired voltage for the device. The control circuit may further allow user to adjust the intensity of output by controlling the duty cycle so that it may be used to control the brightness of light or LED for some application. The control circuit may allow the user to continuously adjust the voltage output to control the brightness of the light or LED. The control circuit may be configured to provide a visual or audio indicator to the user indicative of the current battery state. The control circuit may also provide a graphic display for providing further system information as well as a touch screen for user control.

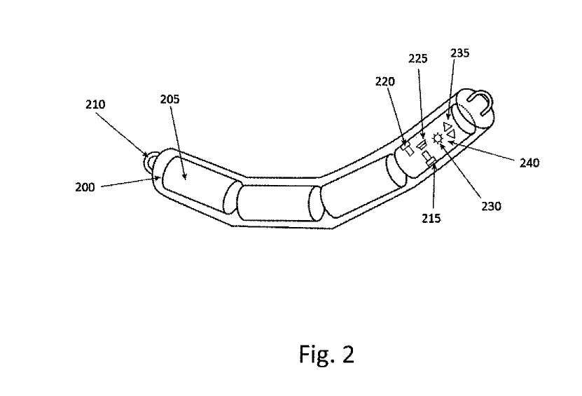

As seen in FIG. 1, the flexible battery pack 100 includes a controller 130, an attachment component 120 and multiple battery sections 155. The dimension of the flexible battery pack may depend on its mounting position on the user's body. For instance, the battery sections may be configured as wide, generally planar sections configured to wrap comfortably around the arm or the leg of the user. The planar sections may have a slight curvature, as shown in FIG. 1, in order to conform to the part of the user's body that the battery pack will be engaged around. On other hand, the battery sections may be in the form of a cylinder, such as the battery pack 200 shown in FIG. 2, or similar narrow shape, suitable to wrap around the neck of the user. The flexible battery pack is as light as possible to reduce the weight applied to the user's body. The number of battery sections 155 provided in a given battery pack 100 depends on the operation lifetime and voltage requirements for the device to be powered by the battery pack. Each battery section may be surrounded entirely or partially by a soft material to provide a comfortable feeling when it is in contact with the user's skin.

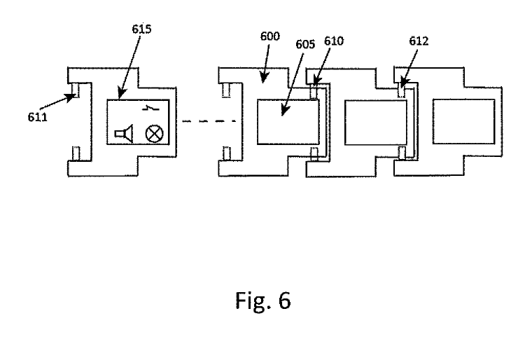

Each battery section may contain at least one battery cell 150 that is either a rechargeable or a replaceable battery. By using small and light battery cells, the size and weight of the battery system may be reduced greatly. Each battery section 155 is connected to an adjacent battery section by a flexible joint 105 that is configured to provide the battery pack 100 with enough flexibility so that the battery pack can easily warp around the arm or neck of the user. One example of a suitable flexible joint 105 is shown in FIG. 6. The battery cells are electrically connected between battery sections 155 by electrical contacts and wires that are flexible so that the contacts and/or wires can traverse the flexible joints 105 between sections.

The control circuit 130 may be embedded within a control module 110 integrated into the flexible battery pack 100. In one embodiment, the control module 100 defines a recess 111 within which the control circuit 130 is mounted. The control module may include an output connector 115 for outputting electrical current to a separate device. The output connector 115 is electrically connected to the control circuit 130 and to the series of battery cells 150 and may be in the form of a conventional connector, such as an electrical jack for receiving an output wire. The control module may also include an input connector 125 for receiving a wire connected to an external charger, for a battery pack in which the battery cells 150 are rechargeable.

The controller 130 may be configured to control the intensity of electrical output using a control knob 135. The knob may also be used to turn on or off the battery output. For instance, the control knob may be a conventional up/down type knob. The controller may also include a visual indicator 140 and/or audio indicator 145 that are operable to provide a signal indicative of the current state of the battery pack 100, with information such as remaining battery lifetime or charging state. The visual indicator may include an LCD display and the controller may operate electronics or software to display system information on the LCD. The controller 130 may further include a touch screen, separate form or integrated into the visual indicator 140, that is operable to allow the user to control the operation and operating state of the battery pack 100.

The controller 130 may be removably mounted to the control module 110 to provide easy access in some applications. The controller 130 may be “hard-wired” to the control module 110 by a wire 131, as shown in FIG. 1. The wire 131 is preferably long enough so that the controller 130 is manually accessible to the user while the user is wearing the flexible battery pack 100. When the controller 130 is mounted within the control module 110, the wire 131 can be coiled and stowed behind the controller in a known manner. Alternatively, the controller 130 and control module 110 may incorporate a wireless communication protocol that allows the controller 130 to be operated apart from and independent of the battery pack 100 to control the battery pack 100 in the same manner as if the controller is integrated into the control module. Thus, regardless where the battery pack is supported on the user's body, the user will be able to manually hold and operate the controller 130 and thus remotely control the operation of the battery pack 100. The controller 130 may also include a wireless transceiver operable to communicate with other third party devices such as a smart phone, watch, or fitness monitor so that the third party device can retrieve the battery status or control the battery output. The third party device, such as a smart phone, may also be used as a visual display for the user, such as by displaying battery pack charging state on the smart phone display.

The battery pack 100 may be provided with an attachment component 120 that is configured to connect to a component suitably configured to support the battery pack on part of the user's body. Thus, in one embodiment, the attachment component 120 may be configured for engagement to a belt or strap that is adapted to encircle the user's arm, leg, torso or neck.

As shown in FIG. 2, a flexible cylindrical battery pack 200 includes cylinder shape batteries 205 embedded within a tubular housing 201 in electrical contact. Electrical contacts and/or wires connect the batteries and accommodate flexing of the battery pack. In one embodiment, the batteries 205 may be maintained in electrical contact by electrically conducting spiral spring contacts engaging the opposing poles of the adjacent batteries. The cylindrical battery pack may be a desirable configuration for wrapping around the neck of the user. The battery pack may include a control module 240, which includes a charging port 215 and an output port 220, similar to the ports 115, 125 described above. As with the controller 130, control module 240 may incorporate a wired or wireless controller 230. The controller may include a button 235 to control the duty cycle of the output. The controller may also contain a visual indicator 230 and/or an audio indicator 225 to indicate the current battery state. The flexible battery pack 200 further includes an attachment component 210 that may be similar to the attachment component 120 described above that can be configured to engage the cylindrical battery pack 200. Alternatively, the attachment component 210 may be configured as an eyelet or ring for attachment to a strap or cable for supporting the battery pack on the user's body. The strap or cable can incorporate or support electrical wires extending from the battery pack 200 to an electrical device supported on the user's body.

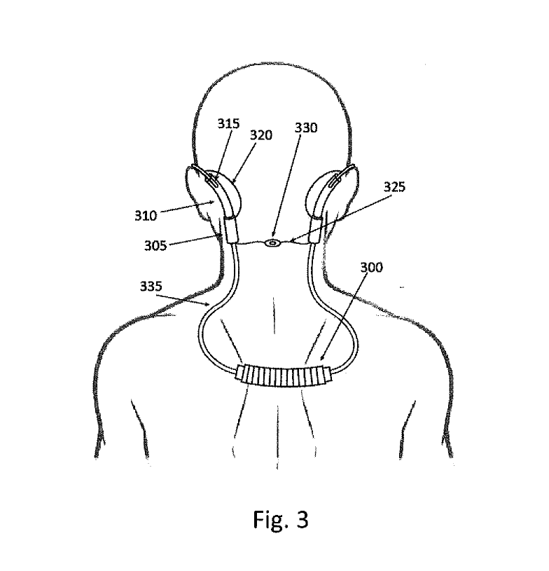

As seen in FIG. 3, a proposed flexible battery system is provided for connection to the frame of goggles or eyeglasses. The battery pack 300 may be one of the battery packs 100, 200 described above. The battery pack is connected to a connector 305 of the goggles frame by a 335. The connector 305 is provided with a sleeve 310 for attachment to each leg of goggle or eyeglass frame. The connector 305 may include a clamp 315 that is configured to provide extra grip on the goggle or eyeglasses as needed. A string 325 may be connected across the two connectors 305 and provided with an adjustable knot 330 that can be used to tighten the string 325 to further secure the system around the head of the user.

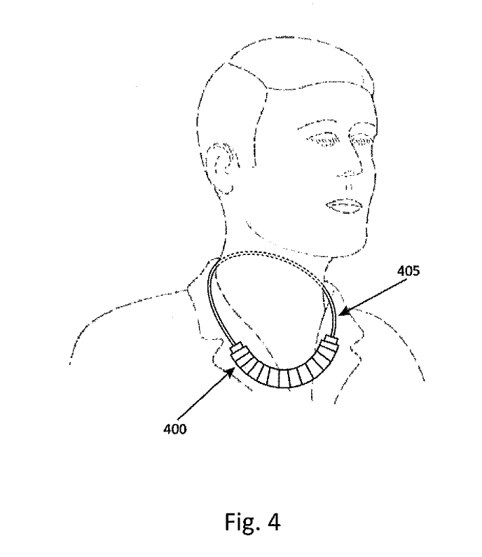

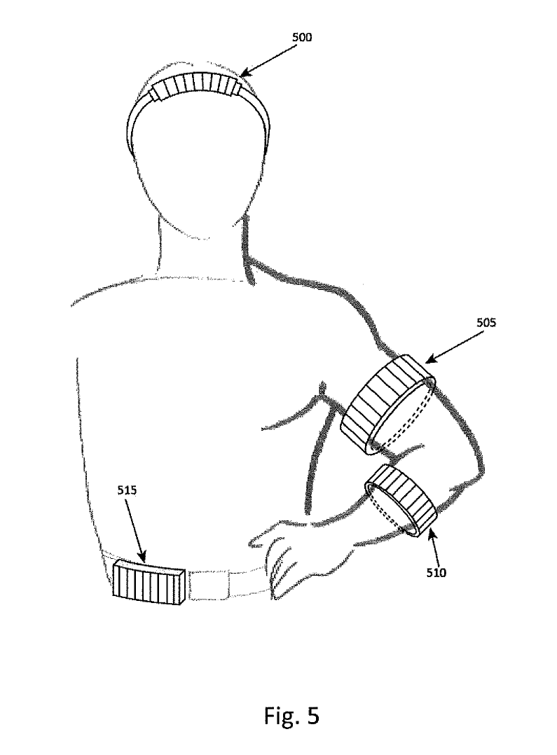

As shown in FIG. 4, a battery pack 400 is attached to a strap 405 to form a flexible battery system that encircles the user's neck. As shown in FIG. 5, the flexible battery system may also be attached to a headband 500, armbands 505 or 510, or to a belt 515, all worn at appropriate parts of the user's body. The battery packs 400, 500 may be either of the battery packs 100, 200 described above.

As shown in FIG. 6, each battery section 600 is connected with each other through the flexible joint 610. The battery sections may be similar to the battery sections of the battery packs illustrated in FIGS. 1-2. The joint 610 between each section allows the entire system to be flexible so that it can wrap around part of human body. In one embodiment, the joint includes opposite pins 611 that are received within corresponding bores 612 so that the battery sections can pivot about the pins 611. The joints 610 are configured so that any number of battery sections may be combined, depending on the required voltage or the battery lifetime. The joint 610 is configured to connect to wires to connect each battery cell 605 to form a complete battery pack. The pins 611 and bores 612 are thus configured to not only physically connect but also to electrically connect the battery cells, such as being formed of an electrically conductive material. The flexible battery system may include a controller 615 in one of the sections, with the controller being electrically connected in series with the battery sections in the same manner as the battery sections.

The present invention contemplates a flexible battery pack system 700 that is connected to a goggle or glass frame G. In particular, the flexible battery pack 700 is mounted on the arms A of goggle or glass frame G through sockets or sleeves 715. The sleeves 715 are configured to receive the arms A of the frame G in a tight fit. The sleeves 715 may thus be formed of a slightly elastic material that is sufficiently elastic to engage the arms A without risk of accidental disengagement, but is still sufficiently loose fitting to allow the arms A to be easily introduced into the sleeves 715. For instance, the sleeves 715 may be configured similar to the neoprene eyeglass retainers sold under the trademark CROAKIES®. The battery pack includes a power wire 705 which connects the flexible battery pack 700 with a power connector 710 associated with an electrical device 725 mounted on the goggles frame G. The power wire 705 is integrated into or positioned inside the sleeves 715 and is integrated into or positioned inside a strap 720 extending from the sleeves to the battery pack 700. The electrical device 725 may be in the form of a power connector mounted in the middle of two lenses of the goggles G, which greatly reduces the wires needed for electrical devices associated with the goggles. The electrical device 725 may be a connector to which another electrical device is engaged, such as a loupe or headlight. Alternatively, the device 725 may be the loupe or headlight itself.

In one feature of certain embodiments of the present invention, the battery pack 700 is mounted to the goggles frame G in a manner to balance the weight of goggle and glass frame. In particular, the weight of the battery pack balances the weight of the lenses and the electrical device 725 mounted to the frame G so that the goggles are supported on the ears of the user with very little pressure on the user's nose. The weight of the device 725, such as a loupe, light or microscope, can become very uncomfortable to the user, particularly during long procedures. The weight of the battery pack 700 balances the weight of the goggles that would otherwise be borne by the user's nose, using the ears as a fulcrum.

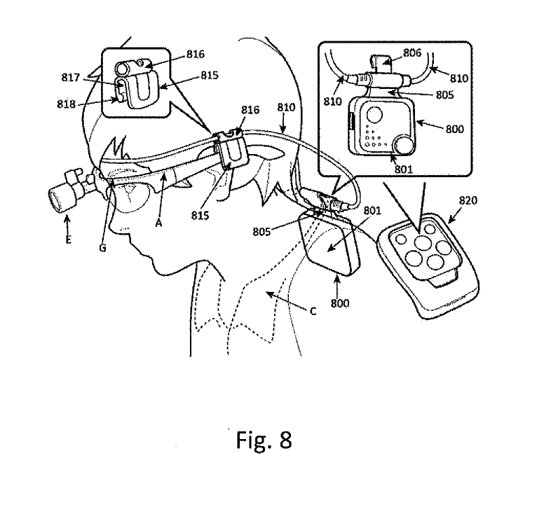

In another embodiment illustrated in FIG. 8, a battery pack 800 includes a housing 801 for supporting a battery cells and a control module in which the housing is configured to be supported on the collar C of the shirt worn by the user. In particular, the housing includes an attachment mechanism 805 that includes a clip 807 configured to clip onto and hang from the user's collar C. The attachment mechanism 805 further includes an output connector 806 configured to receive power wires 810 that are associated with an electrical device E mounted on goggles or eyeglasses G. The output connector can provide a hard-wired connection of the power wires 801 to the battery pack 800, or more preferably can constitute a conventional electrical connector, such as a plug-in jack, to receive an associated connector on the wires 810.

The wires 810 are supported on the arms A of the goggles frame G by clips 815. The clips 815 include a support tube 816 through which the wires 810 extend. A spring clip 817 includes a flange 818 that is adapted to engage the arms A of the goggles to support the wires on the arms A. The battery pack 800 may be provided with a remote control device 820 that communicated wirelessly with the control module within the battery pack 800. The control module can be similar in function to the control module 110/130 discussed above. The remote control device 820 can thus operate the control module to control the function of the battery pack 800, and more specifically control the electrical output to the electrical device E.

It can be appreciated that the clips 815 may be combined with the flexible battery packs 100, 200, 700 described above. The clips could thus replace the sleeves 715 for supporting battery pack 700 on the goggles/eyeglasses G of the user.

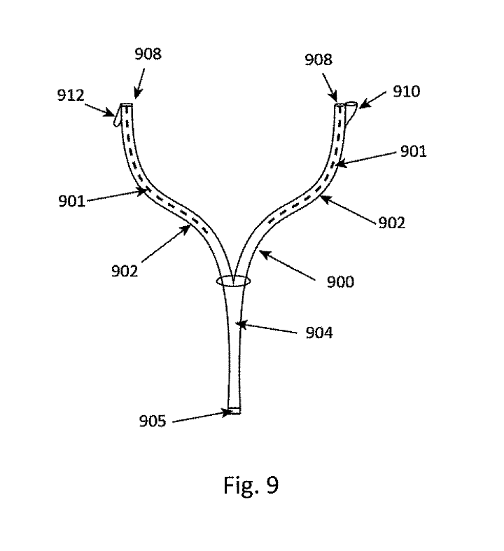

In a further embodiment shown in FIG. 9, a power strap 900 includes a pair of flexible battery packs, such as the battery pack 200 shown in FIG. 2, that are integrated into flexible arms 902 of the power strap. The flexible arms 902 merge into a central arm 904 that can incorporate a charging port 905 for connecting the battery cells in the flexible battery packs 901 to a power source for re-charging the battery cells.

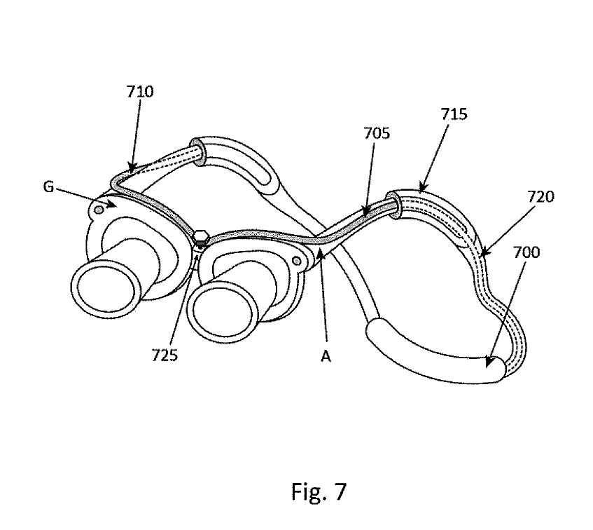

The flexible arms 902 are configured to sit at the back of the user's head with the ends 908 configured to engage the arms A of the goggles or eyeglasses G in the manner of the sleeves 715 shown in FIG. 7. The ends 908 are also provided with an output connector 910 for connection of an electrical wire between the power strip 900 and an electrical device supported on the eyeglasses/goggles. The ends 908 are configured to reside adjacent the temple of the user wearing the goggles/eyeglasses. In this position, a control element 912 may be supported at one or both ends 908 to provide a simple push-button intensity control to adjust the output o the battery packs 901.

In one embodiment, the flexible arms 902 may be configured of a flexible material, such as neoprene, that can support the battery packs 901 when the arms are engaged to the user's goggles/eyeglasses. The flexible arms thus allow the battery packs 901 housed within the arms to counter-balance the weight of the goggles/eyeglasses and associated electrical device when worn by the user.

It is understood that the battery systems disclosed herein are readily adapted to provide power to electrical devices worn by the user in some manner. The systems disclosed herein are particularly suited to supply power to electrical devices supported on goggles or eyeglasses worn by the user. The battery systems disclosed herein incorporate a control section or a controller that is configured to control the operation of the battery packs, and more particularly to control the output of electrical energy to the electrical device. This control can be of simply the magnitude of the output voltage, or may provide more sophisticated control of the power duty cycle. The battery systems disclosed herein contemplate a wireless system in which the on-board control section or controller may itself be remotely controlled by a hand-held control device, including a third-party device such as a smart phone.

The battery pack apparatuses disclosed herein include an electrical wires or power cables for connection between the battery pack and the electrical device or an electrical socket on the device. The electrical wires have a length sufficient to extend between the battery pack and the electrical device regardless where the battery pack is supported. Moreover, the length of the wires is limited to eliminate excessive slack in the wires so that the wires will not interfere with the motion of the user or get snagged as the user moves. Thus, the for the embodiments in which the battery pack includes an attachment component for supporting the battery pack on the collar of a shirt or on a belt worn around the waist of the user, the length of the wires are sufficient to extend between the supported battery pack and the electrical device without excess slack.

The present disclosure should be considered as illustrative and not restrictive in character. It is understood that only certain embodiments have been presented and that all changes, modifications and further applications that come within the spirit of the disclosure are desired to be protected.

What is claimed is:

1. A battery pack apparatus comprising:
a plurality of electrically connected battery sections, each battery section including a corresponding battery cell;
a control section electrically connected to the battery sections, said control section configured to control the operation of the battery pack and including an output connection, the output connection configured to electrically engage a power wire for electrical connection to an electrical device worn by a user;
a flexible joint connecting each of said battery sections to provide a flexible battery pack apparatus adapted to be worn by the user.

2. The battery pack apparatus of claim 1, wherein the battery sections are cylindrical.

3. The battery pack apparatus of claim 1, wherein the battery sections are generally planar.

4. The battery pack apparatus of claim 1, therein the control section is operable to provide a fixed voltage output.

5. The battery pack apparatus of claim 1, wherein the control section includes a controller removably mounted to the control section, the controller configured to control the operation of the battery pack.

6. The battery pack apparatus of claim 5, wherein the controller includes audio and/or visual indicators and the controller is configured to activate the indicators in response to the performance of the battery pack.

7. The battery pack apparatus of claim 6, wherein the controller is connected by a wire to the control section.

8. The battery pack apparatus of claim 6, wherein the control section and the controller include a wireless connection therebetween.

9. The battery pack apparatus of claim 1, wherein battery cells of the battery sections are rechargeable and the control section includes a port for electrical connection to a device for recharging the battery cells.

10. The battery pack apparatus of claim 1, wherein each battery section includes a plurality of battery cells.

11. The battery pack apparatus for supplying electrical power to an electrical device mounted on a goggles or eyeglasses worn by a user, the apparatus comprising:
a battery pack including a plurality of battery cells;
an attachment component associated with the battery pack and configured for attachment to the arms of the goggles or eyeglasses; and
at least one electrical wire carried by the attachment component, the wire connected to the battery pack and connectable to the electrical device,
wherein the battery pack is supported by the attachment component when the attachment component is engaged to the arms of the goggles or eyeglasses to counter-balance the weight of at least the electrical device mounted on the goggles or eyeglasses when worn by the user.

12. The battery pack apparatus of claim 11, wherein the attachment component includes a pair of sleeves configured to engage the arms of the goggles or eyeglasses.

13. The battery pack apparatus of claim 12, wherein the at least one electrical wire is incorporated into a corresponding one of the pair of sleeve.

14. The battery pack apparatus of claim 11, wherein the attachment component includes:
a pair of clips, each configured to removably engage a corresponding arm of the goggles or eyeglasses; and
a tube integrally formed with at least one of the pair of clips and receiving a corresponding one of said at least one electrical wire.

15. The battery pack apparatus of claim 11, wherein the battery cells of the battery pack are rechargeable and the battery pack includes a port for electrical connection to a device for recharging the battery cells.

16. The battery pack apparatus for supplying electrical power to an electrical device mounted on a goggles or eyeglasses worn by a user, the apparatus comprising:
a battery pack including a plurality of battery cells;
an attachment clip associated with the battery pack and configured for attachment to clothing worn by the user;
at least one electrical wire connected to the battery pack and connectable to the electrical device, the at least one electrical wire having a length sufficient to extend between the battery pack and the electrical device without significant slack; and
at least one clip configured to removably engage a corresponding arm of the goggles or eyeglasses, the clip including an integral tube integrally configured to receive a corresponding one of said at least one electrical wire.

17. The battery pack apparatus of claim 16, wherein:
the battery pack includes a controller operable to control the operation of the battery cells.

18. The battery pack apparatus of claim 17, wherein the controller includes a remote control component configured for wireless communication with the battery pack to control the operation of the battery cells.

19. The battery pack apparatus of claim 16, wherein the attachment clip is configured to attach to the collar of a shirt worn by the user.

20. The battery pack apparatus of claim 16, wherein the attachment clip is configured to attach to a belt worn by the user.
